(19) United States
(12) Patent Application Publication
(10) Pub. No.: US 2009/0044793 A1
(43) Pub. Date: Feb. 19, 2009

(54) FURNACE BURNER BOX

(75) Inventors: Tabraiz Ali KHAN, Wichita, KS (US); Robert CABRERA, Wichita, KS (US); Gregory Kenneth REASER, Wichita, KS (US)

Correspondence Address: MCNEES WALLACE & NURICK LLC, 100 PINE ST., P.O. BOX 1166, HARRISBURG, PA, 17108-1166, US

(73) Assignee: JOHNSON CONTROLS TECHNOLOGY COMPANY, Holland, MI (US)

(21) Appl. No.: 12/142,854

(22) Filed: Jun. 20, 2008

Related U.S. Application Data
(60) Provisional application No. 60/955,686, filed on Aug. 14, 2007.

(51) Int. Cl. F24H 9/02; B23P 19/04

(52) U.S. Cl. 126/114; 29/700

(57) ABSTRACT

A burner box for a furnace. The burner box includes a housing attached to the furnace. The burner box further includes a module configured to align and support a burner within the housing. The module is detachable from the housing and removable from the furnace burners. The module is detachable from the housing without disassembly or detachment of the housing from the furnace.

### CROSS-REFERENCE TO RELATED APPLICATIONS

This application claims the benefit of U.S. Provisional Application No. 60/955,686, filed Aug. 14, 2007, which is hereby incorporated by reference in its entirety.

### BACKGROUND

The application relates generally to furnaces and other systems utilizing burners and burner boxes.

A typical furnace includes a burner, a heat exchanger, an air distribution system, a control system and an exhaust system. In the burner, a fuel such as gas (natural or propane) or oil is delivered and burned to generate heat. A heat exchanger transfers heat from the burning fuel to the air flowing through the distribution system. An exhaust system such as a vent pipe or flue exhausts products of combustion from the burner (such as water vapor and carbon dioxide) outside of the enclosed space, for example, a home being heated by the furnace. The distribution system, which includes a blower and ductwork, delivers the heated air throughout the enclosed space and returns cooler air to the furnace to be heated.

During operation, the burner may become fouled and/or damaged due to impurities in the fuel and/or extended operation. Therefore, to extend the life of the burners, removal and cleaning, servicing and/or replacing of the burners can be periodically performed. The burner typically includes a housing and burner nozzles disposed in the housing. Previous housing and burner nozzle configurations affixed the burners within the housing and affixed the housing to the furnace. By affixing the burners within the housing and affixing the housing to the furnace, the housing and burner must be disassembled, including the detachment/disassembly of the fuel line, which is undesirable, when cleaning, servicing and/or replacement of the burner is required.

Intended advantages of the systems and/or methods satisfy one or more of these needs or provide other advantageous features. Other features and advantages will be made apparent from the specification. The teachings disclosed extend to those embodiments that fall within the scope of the claims, regardless of whether they accomplish one or more of the aforementioned needs.

### SUMMARY

One embodiment is directed to a burner box for a furnace. The burner box includes a housing attached to the furnace. The burner box further includes a module configured to align and support a burner within the housing. The module is detachable from the housing and removable from the furnace burners. The module is detachable from the housing without disassembly or detachment of the housing from the furnace.

Another embodiment is directed to a furnace having a burner box. The burner box includes a housing affixed to a portion of the furnace, a fuel valve arranged and disposed to provide fuel to a burner and a module configured to align and support the burner within the housing and operably positioned with respect to the fuel valve. The module is detachable from the housing and removable from the furnace, without disassembly or detachment of the housing or fuel valve from the furnace.

A further embodiment is directed to a method of servicing a furnace. The method includes providing a burner box. The burner box includes a housing affixed to a portion of the furnace, a fuel valve arrangement arranged and disposed to provide fuel to a burner and a detachable module configured to align and support the burner within the housing and operably positioned with respect to the fuel valve. The detachable module is detachable from the housing and removable from the furnace, without disassembly or detachment of the housing from the furnace. The method further includes removing the detachable module and the burner from the housing and the furnace without disassembly or detachment of the housing or fuel valve from the furnace.

Alternative exemplary embodiments relate to other features and combinations of features as may be generally recited in the claims.

### BRIEF DESCRIPTION OF THE FIGURES

FIG. 1 is an illustration of an exemplary furnace disposed in a residential setting.

FIG. 2 is a schematic arrangement of an embodiment of a furnace.

FIG. 3 is a front perspective view of an embodiment of a burner box.

FIG. 4 is a rear perspective view of the burner box of FIG. 3.

FIGS. 5-6 illustrate the removal of the module from the housing.

FIG. 7A shows a top perspective view of the module according to one embodiment.

FIG. 7B shows a top plan view of the module according to one embodiment.

FIG. 7C shows an elevational front view of the module according to one embodiment.

FIG. 7D shows an elevational side view of the module according to one embodiment.

FIG. 8A shows a top perspective view of a housing according to one embodiment.

FIG. 8B shows a top plan view of the housing according to one embodiment.

FIG. 8C shows an elevational front view of the housing according to one embodiment.

### DETAILED DESCRIPTION OF THE EXEMPLARY EMBODIMENTS

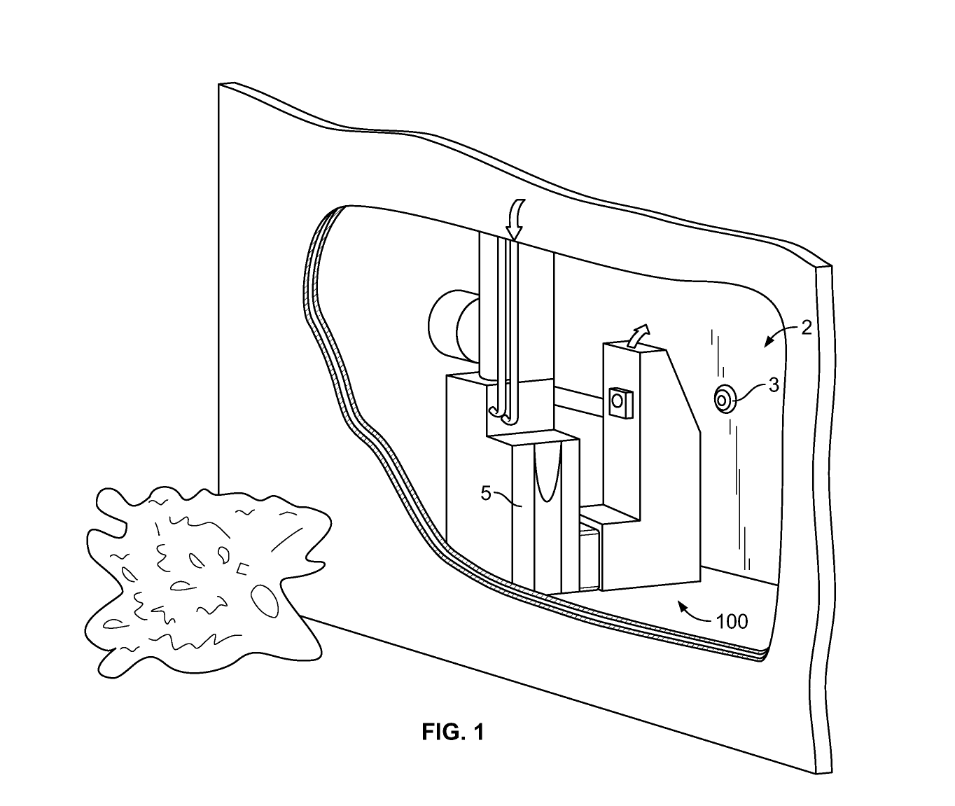

FIG. 1 shows an exemplary furnace 100 in a typical residential setting 2. Furnace 100 is disposed within an enclosed space of the residential setting 2. In furnace 100, air is drawn into furnace system 100 and subsequently heated by exchanging heat with products of combustion generated by burning a fuel in furnace 100. A thermostat 3 or similar device that monitors and controls the conditions within the enclosed space may be used to provide temperature control to the enclosed space by controlling the operation of furnace 100. An air distribution system 5 including an air mover such as a blower or other similar device may be used to distribute air to the enclosed space in residential setting 2. In another embodiment, furnace 100 can be incorporated in a heating, ventilation and air conditioning (HVAC) system for the enclosed space. The HVAC system can provide both heating to the enclosed space using furnace 100 and cooling to the enclosed space using a vapor compression system.

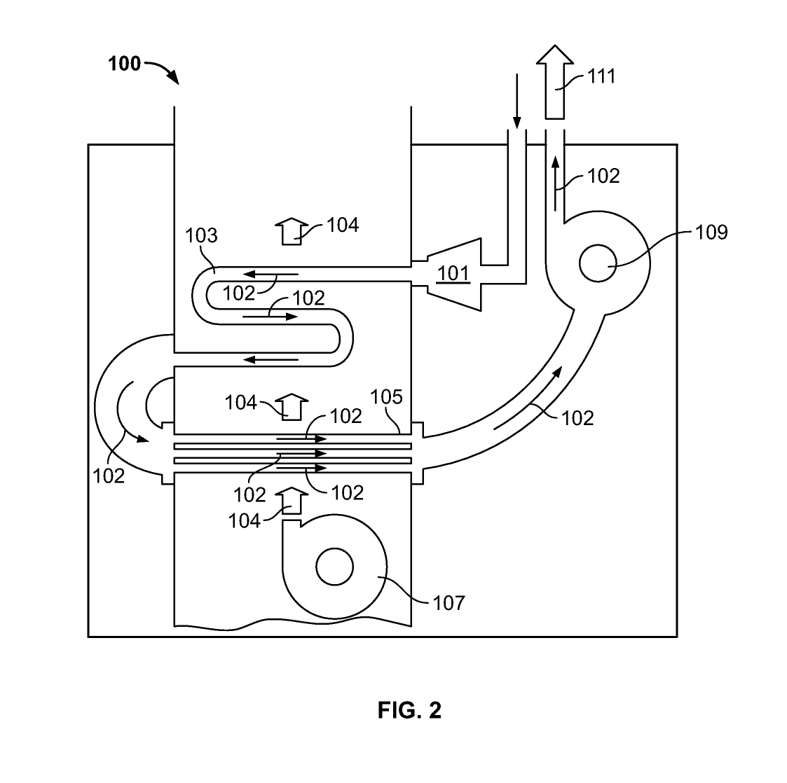

FIG. 2 shows a schematic arrangement of furnace 100. During operation, a burner 101 combusts fuel, for example, a gas (natural or propane) or oil, with combustion air and provides heated combustion products 102, e.g., water vapor and carbon dioxide, to a first heat exchanger 103, where heat is transferred to a supply air 104. Supply air 104 is air that is to be heated, such as interior air for the enclosed space. Combustion products 102 can then be directed into a second heat exchanger 105 as shown in the embodiment of FIG. 2, where heat is exchanged with supply air 104. Supply air 104 can be directed over first heat exchanger 103 and second heat exchanger 105 by use of a blower 107 or similar air-moving device. Combustion products are then exhausted from furnace 100 by use of an exhaust blower 109 or other air-moving device. Exhaust 111 includes air, water vapor and other combustion products. Furnace 100 provides heat to supply air 104 by use of first heat exchanger 103 and second heat exchanger 105. Supply air 104 is then provided to the enclosed space for heating.

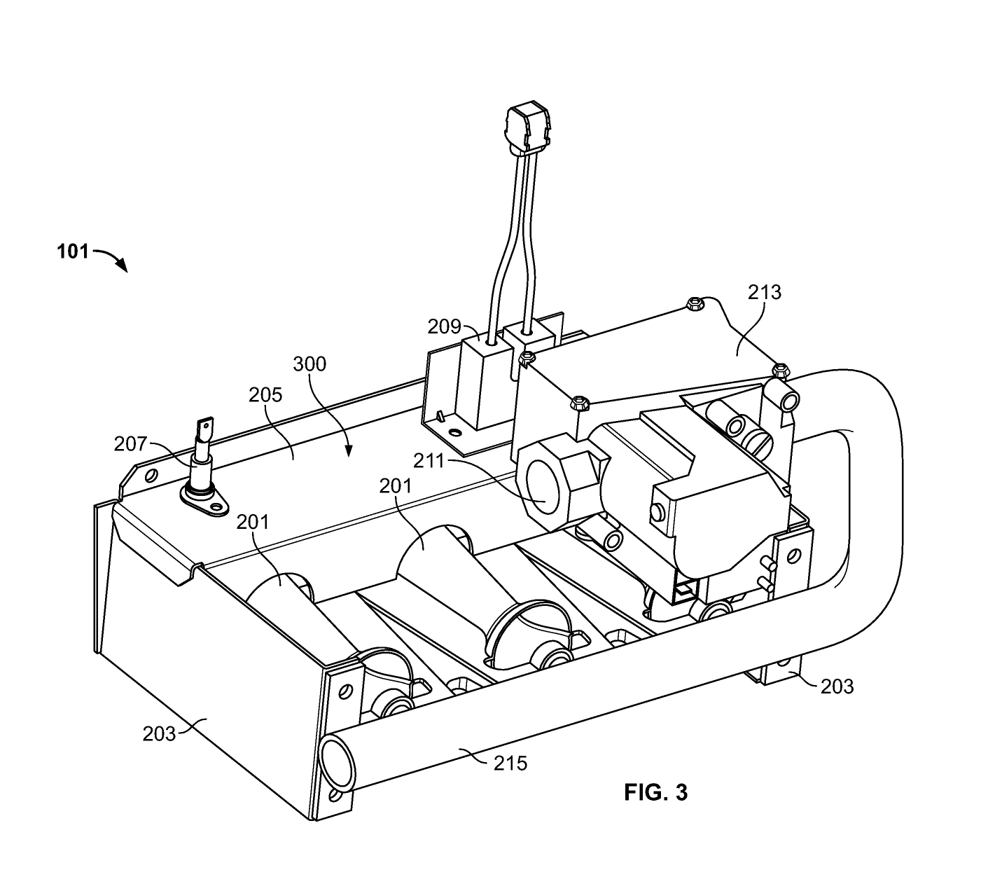

FIG. 3 shows an embodiment of a “burner” assembly 101. Assembly 101 includes burners 201, which ignite fuel, providing for combustion of the fuel and thereby the generation of heat for furnace system 100. Assembly 101 further includes a housing 203, which houses burners 201 and attaches to a component of furnace 100. Attachment of housing 203 to a component of furnace 100 may take place using fasteners, for example, screws, bolts or clips, or non-fastener methods, e.g., adhesives or welding. Housing 203 provides containment and directional flow of combustion air to burner 201 and first heat exchanger 103. Housing 203 and a module 205 form a burner box into which burners 201 are positioned. Module 205 is affixed to burners 201 and connectable to housing 203 and/or a component of furnace 100. Module 205 and burners 201 may be affixed to each other using fasteners, for example, screws, bolts or clips or non-fastener methods, e.g., adhesives or welding. In addition, burners 201 and module 205 may be fabricated as a unitary component. Module 205 is detachable from housing 203 to permit burners 201 and module 205 to be removed from furnace 100. Module 205, when fastened into position, forms the burner box, which provides a structure sufficient to contain and/or direct combustion air during operation of furnace 100. Module 205 further provides support and alignment of burners 201 in furnace 100. The burner box formed by module 205 and housing 203 is not limited to the geometry shown and may include any geometry that provides containment and direction for combustion air and support to burners 201.

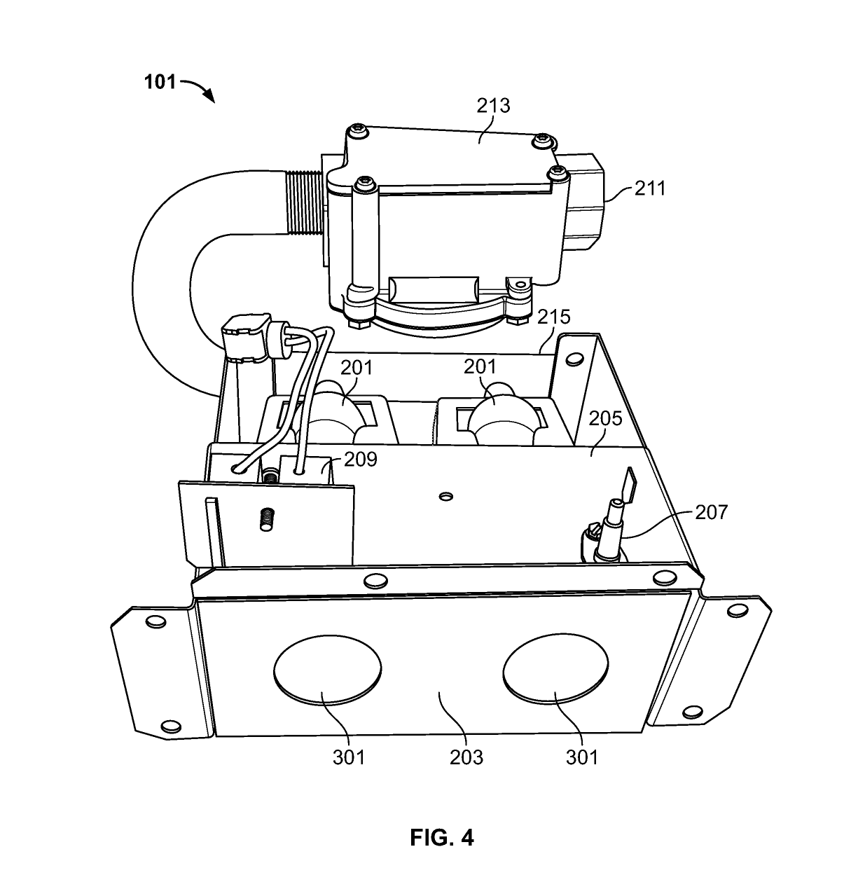

Module 205 may further include an igniter 209 or other ignition source and a sensor 207, such as a thermocouple. Although sensor 207 and igniter 209 are shown to be included on module 205, sensor 207 and igniter 209 may be disposed within housing 203 or any other suitable location. To operate assembly 101, fuel is provided by a hose or other conduit (not shown) to a fuel coupling 211. The fuel may be natural gas, propane, oil or any other fuel suitable for use in a furnace. The fuel enters a fuel valve 213, which selectively provides fuel to fuel manifold 215. Fuel valve 213 may be any suitable fuel valve and may include a filter, filtering or other structure used with fuel valves. Fuel manifold 215 distributes the fuel to the burners 201. Although three burners 201 are shown in FIG. 3, any number of burners 201 may be utilized, including more than three burners 201 and less than three burners 201 (see for example, FIG. 4). Burners 201 may be any burner device suitable for use in a furnace. The fuel enters burners 201 and is ignited by igniter 209 or other ignition source. The resultant combustion results in heated combustion products 102, which can exchange heat with supply air 104 in first and second heat exchangers 103 and 105.

When servicing of assembly is desired, module 205 may be detached from housing 203 and/or furnace 100 and may be removed. Components such as igniter 209 and/or sensor 207 may be detached using connectors or similar detachment devices or may be removed from module 205 during removal of module 205. Burners 201 attached to module 205 are accessible for servicing once module 205 has been removed. Servicing, as utilized herein, may include activities, such as cleaning, inspecting, repairing, rebuilding, replacing or otherwise providing maintenance to module 205 and/or burners 201. Upon completion of servicing, module 205, including burners 201, may be reinstalled and fastened into position with respect to housing 203. Upon reinstallation, module 205 in combination with housing 203 forms the burner box and contains and/or directs combustion air during operation of furnace 100. During servicing, module 205 may be partially or entirely replaced, wherein burners 201 may be replaced and reattached to module 205 or replacement modules 205 having new, or previously cleaned/serviced burners 201 may be installed to reduce furnace downtime.

FIG. 4 shows a rear perspective view of assembly 101. To operate assembly 101, fuel is provided by a hose or other conduit (not shown) to fuel coupling 211. The fuel enters fuel valve 213, which selectively provides fuel to fuel manifold 215. Fuel manifold 215 distributes the fuel to burners 201. Burners 201 are supported and aligned by module 205 such that fuel manifold 215 provides the fuel to burners 201. Burner openings 301 in housing 203 permit the escape of combustion products 102 from assembly 101 into first heat exchanger 103 and second heat exchanger 105 for heat transfer with the supply air 104. Burners 201 provide the non-combusted fuel to the burner box formed by module 205 and housing 203. Igniter 209 provides an ignition source, which results in combustion and the formation of combustion products 102. Combustion products 102 are exhausted through openings 301 in housing 203.

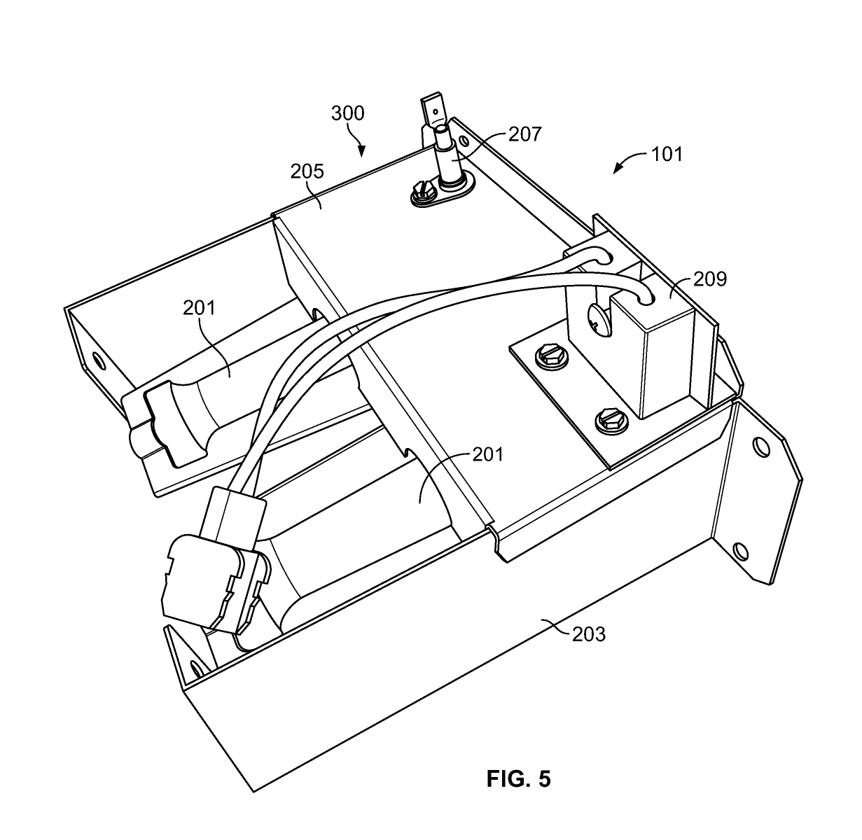

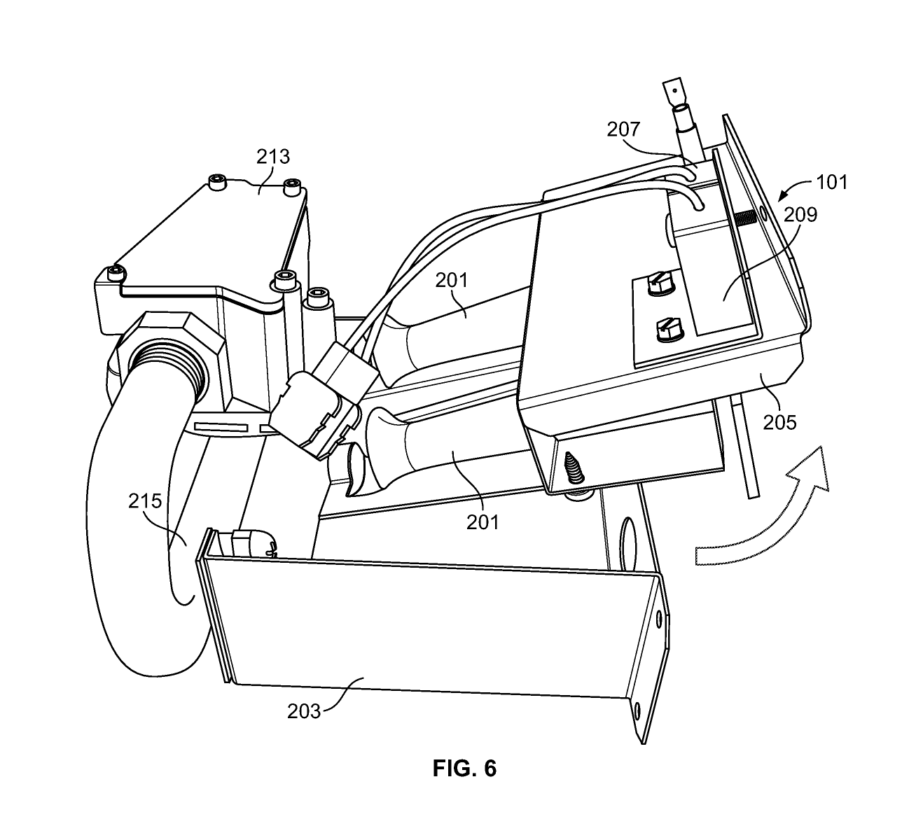

FIGS. 5-6 show the removal of module 205 in one embodiment. FIG. 5 shows a burner box formed by module 205 and housing 203. In order to remove module 205, fasteners, such as screws, bolts or clips, retaining module 205 to housing 203 and/or the furnace 100 are released and/or removed. In addition, wiring, cabling or other connections to igniter 209 and/or sensor 207 may be detached or otherwise removed. Alternatively, igniter 209 and/or sensor 207 may be removed from module 205 before module 205 is removed. As shown in FIG. 6, module 205, including burners 201, may be directed from housing 203 and removed for servicing. Module 205 is configured to permit the removal of burners 201 and any components, such as igniter 209 and/or sensor 207 so that servicing can be facilitated without removing housing 203 from furnace 100 or disconnecting or manipulating fuel valve 213 or fuel manifold 215 from housing 203 or furnace 100. In addition to permitting removal of burners 201, the removal of module 205 permits access to the interior surfaces of the burner box for inspection and/or servicing without removal of housing 203 from furnace 100.

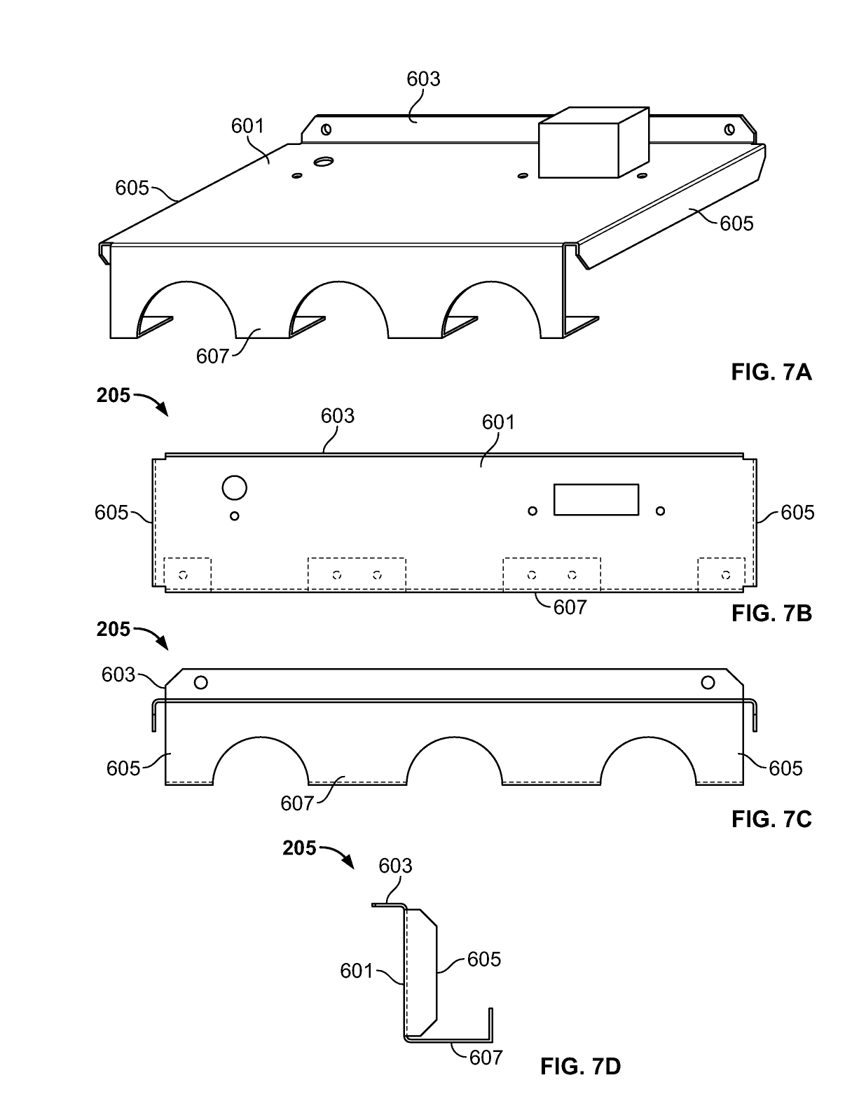

FIGS. 7A-7D show various views of one embodiment of module 205. Module 205 includes a body 601 that extends from a flange 603 to a burner plate 607. Flange 603 is attachable to a component of furnace 100 by any suitable attachment method, including fastening, welding or latching to a component of furnace 100. Plate 607 is configured to attach, conform, receive and/or otherwise be disposed in close proximity to burners 201. In one embodiment, burners 201 are attached to plate 607 and are removable with module 205. Body 601 further includes an alignment flange 605 configured to mate, engage or otherwise align module 205 onto housing 203. Alignment flange 605 extends from body 601 and when engaged with housing 203, provides containment sufficient to permit combustion from burners 201. As shown in FIGS. 7C and 7D, flange 603 and plate 607 extend in substantially opposite directions, wherein flange 603 is arranged in a position wherein flange 603 is sufficiently accessible to facilitate disengagement or release. For example, fasteners used to hold flange 603 may be unfastened to permit removal of module 205.

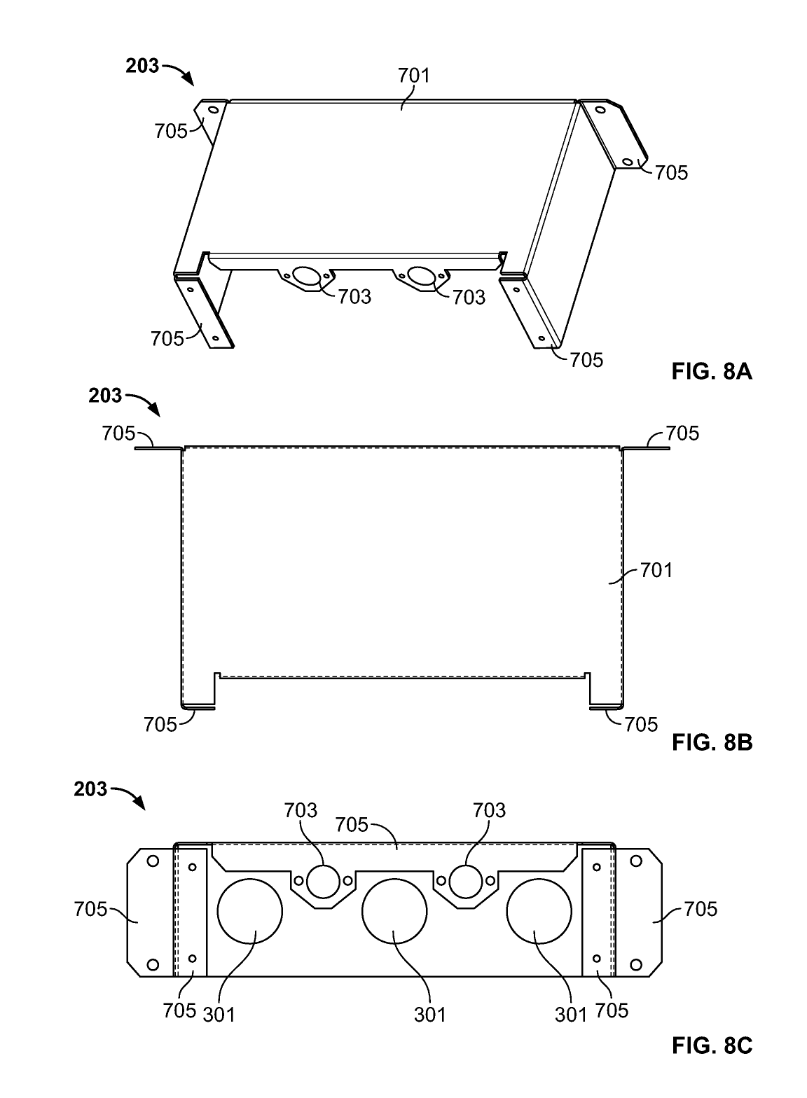

FIGS. 8A-8C show various views of one embodiment of housing 203. Housing 203 includes a housing body 701 with a geometry that, when engaged with module 205, partially encloses a chamber suitable for combustion. As shown, housing 203 includes flanges 705 arranged to permit mounting of housing 203 to a component of furnace 100. Housing body 701 further includes alignment structures 703 which are configured to align burners 201. While not so limited, alignment structure 703 may include fasteners or other devices to provide support or connection to fuel manifold 215. As shown in FIG. 8C, housing 203 includes openings 301, which permit the passage of combustion products 102. Upon engagement of module 205, housing 203 and module 205 form a burner box suitable for facilitating combustion by burners 201 and operation of furnace system 100.

It should be understood that the application is not limited to the details or methodology set forth in the description or illustrated in the figures. It should also be understood that the phraseology and terminology employed herein is for the purpose of description only and should not be regarded as limiting.

While the exemplary embodiments illustrated in the figures and described are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

It is important to note that the construction and arrangement of the systems as shown in the various exemplary embodiments is illustrative only. Although only a few embodiments have been described in detail in this disclosure, those skilled in the art who review this disclosure will readily appreciate that many modifications are possible (for example, variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

1. A burner box for a furnace comprising:
a housing attached to the furnace;
a module configured to align and support a burner within the housing, the module being detachable from the housing and removable from the furnace; and
wherein the module is detachable from the housing and removable from the furnace without disassembly or detachment of the housing from the furnace.

2. The burner box of claim 1, wherein the module and the burner are configured as a unitary component.

3. The burner box of claim 1, wherein the burner is detachably affixed to the module.

4. The burner box of claim 1, wherein the module comprises a flange configured and disposed to permit attachment of the module to the housing.

5. The burner box of claim 1, wherein the module comprises a plate, the plate being configured and disposed to connect to the burner.

6. The burner box of claim 1, wherein the module is attachable to the housing by at least one fastener.

7. The burner box of claim 1, wherein the module and housing form a passageway for combustion air upon attachment of the module to the housing.

8. The burner box of claim 1, wherein the module includes a body having a plurality of flanges and at least one plate attached thereto, and at least one flange of the plurality of flanges being disposed at opposite ends of the body.

9. The burner box of claim 1, wherein the module includes a body having a plurality of flanges, and at least two flanges extend in opposite directions.

10. A furnace having a burner box, the burner box comprising:
a housing affixed to a portion of the furnace;
a fuel valve arranged and disposed to provide fuel to a burner;
a module configured to align and support the burner within the housing and operably positioned with respect to the fuel valve, the module being detachable from the housing and removable from the furnace; and
wherein the module is detachable from the housing and removable from the furnace without disassembly or detachment of the housing or fuel valve from the furnace.

11. The furnace of claim 10, wherein the module and the burner are configured as a unitary component.

12. The furnace of claim 10, wherein the burner is detachably affixed to the module.

13. The furnace of claim 10, wherein the module comprises a flange configured and disposed to permit attachment of the module to the housing.

14. The furnace of claim 10, wherein the module comprises a plate, the plate being configured and disposed to connect to the burner.

15. The furnace of claim 10, wherein the module is attachable to the housing by at least one fastener.

16. The furnace of claim 10, wherein the module and housing form a passageway for combustion air upon attachment of the module to the housing.

17. The furnace of claim 10, wherein the module includes a body having a plurality of flanges and at least one plate attached thereto, and at least one flange of the plurality of flanges being disposed at opposite ends of the body.

18. The furnace of claim 10, wherein the module includes a body having a plurality of flanges, and at least two flanges extend in opposite directions.

19. A method of servicing a furnace comprising:
providing a burner box comprising:
a housing affixed to a portion of the furnace;
a fuel valve arranged and disposed to provide fuel to a burner;
a detachable module configured to align and support the burner within the housing and operably positioned with respect to the fuel valve, the detachable module being detachable from the housing and removable from the furnace system; and
wherein the detachable module is detachable from the housing and removable from the furnace without disassembly or detachment of the housing from the furnace; and
removing the detachable module and the burner from the housing and the furnace without disassembly or detachment of the housing or fuel valve from the furnace.

20. The method of claim 19, further comprising replacing at least one of the one or more burners.

21. The method of claim 19, further comprising servicing at least one of the one or more burners.

22. The method of claim 20, further comprising replacing at least one component.

23. The method of claim 21, further comprising servicing at least one component.
